(19) United States
(12) Patent Application Publication
(10) Pub. No.: US 2020/0040864 A1
(43) Pub. Date: Feb. 6, 2020

(54) STRUCTURE OF BUOYANCY POWER GENERATION

(71) Applicant: Mo-Chung Huang, New Taipei City (TW)

(72) Inventor: Mo-Chung Huang, New Taipei City (TW)

(21) Appl. No.: 16/504,331

(22) Filed: Jul. 8, 2019

(30) Foreign Application Priority Data
Aug. 2, 2018 (TW) 107210583

(51) Int. Cl. F03B 13/10

(52) U.S. Cl. CPC F03B 13/10

(57) ABSTRACT

A structure of buoyancy power generation includes a buoyancy assembly, at least one rail adapted to allow the buoyancy assembly to be in slidable connection with it, at least one fixing element configured on the rail, an air supply device in connection with one side of the buoyancy assembly and a wave power generation assembly configured on one side of the buoyancy assembly. With the above structure, a user may install the buoyancy assembly and rail in a pool, and air is put into the buoyancy assembly through the air supply device, allowing the buoyancy assembly to generate buoyancy and float upward along the rail to the water surface, thereby generating waves on the water surface, and the wave power generation assembly is configure on the shore of the pool, capable of converting the waves generated on the water surface to electric power.

### (a) TECHNICAL FIELD OF THE INVENTION

The present invention relates to a structure of buoyancy power generation, and more particularly to a structure of buoyancy power generation utilizing buoyancy to achieve environmentally friendly power generation.

### (b) DESCRIPTION OF THE PRIOR ART

After the industrial revolution, the speed of industrial progress is as fast as a volcanic eruption, and the so-called “industrial progress” is the process of mostly the process of using machinery to gradually replace manpower. When machines are working, the supply of electricity is naturally indispensable. In contrast, with the advancement of various machinery, the ways of generating electricity are naturally continuously improved; for example, they are developed from the most commonly used thermal power generation to the current highest power generation nuclear power generation. But, regardless of the type of power generation, there is the pollution of the environment. For example, exhaust gas from thermal power generation, nuclear waste generated by nuclear power generation, etc. are all pollution sources that destroy the earth. Therefore, modern people gradually start developing environmentally friendly energy sources such as solar energy, water power, wind power. But, no matter what kind of environmentally friendly energy source, the current power supply is not enough to replace the original power generation methods; the main reason is that the cost and power generation efficiency are worse than original power generation methods.

### SUMMARY OF THE INVENTION

To overcome the disadvantages mentioned above, the present invention is proposed.

The main object of the present invention is to allow a pool to generate waves through a buoyancy assembly operated in coordination with an air supply device, thereby achieving an environmentally friendly power generation effect and using lower cost to obtain higher power generation efficiency.

To achieve the above object, the main structure of the present invention includes a buoyancy assembly, at least one rail adapted to allow the buoyancy assembly to be in slidable connection with it, at least one fixing element configured on the rail, an air supply device in connection with one side of the buoyancy assembly and a wave power generation assembly configured on one side of the buoyancy assembly.

With the above structure, a user may install the buoyancy assembly and rail in a pool, and air is put into the buoyancy assembly through the air supply device, allowing the buoyancy assembly to generate buoyancy and float upward along the rail to the water surface, thereby generating waves on the water surface, and the wave power generation assembly is configure on the shore of the pool, capable of converting the waves generated on the water surface to electric power. In the above actions, no untreatable garbage or pollution will be produced. In addition, the cost is low and the wave power generation assemblies can be increased and buoyancy assembly can be enlarged according to user's requirements, thereby increasing power generation efficiency so that the low-cost and high-efficiency environmentally friendly power generation method can be obtained.

### BRIEF DESCRIPTION OF THE DRAWINGS

FIG. 1 is a perspective view of a preferred embodiment of the present invention;

FIG. 2 is an exploded view of the embodiment of the present invention;

FIG. 3 is another perspective view of the embodiment of the present invention;

FIG. 4 is a schematic view of the embodiment of the present invention, showing air filling and water discharge;

FIG. 5 is a schematic view of the embodiment of the present invention, where a barrel is released and floats up;

FIG. 6 is a schematic view of the embodiment of the present invention, where first and second magnetic elements are in touch with each other;

FIG. 7 is a schematic view of the embodiment of the present invention, where a cover is opened to discharge air;

FIG. 8 is a schematic view of the embodiment of the present invention, where the barrel is sunk to close the cover;

FIG. 9 is a schematic view of the embodiment of the present invention, where waves are generated; and

FIGS. 10 and 11 respectively are a schematic view of the power generation of the embodiment of the present invention.

### DETAILED DESCRIPTION OF THE PREFERRED EMBODIMENTS

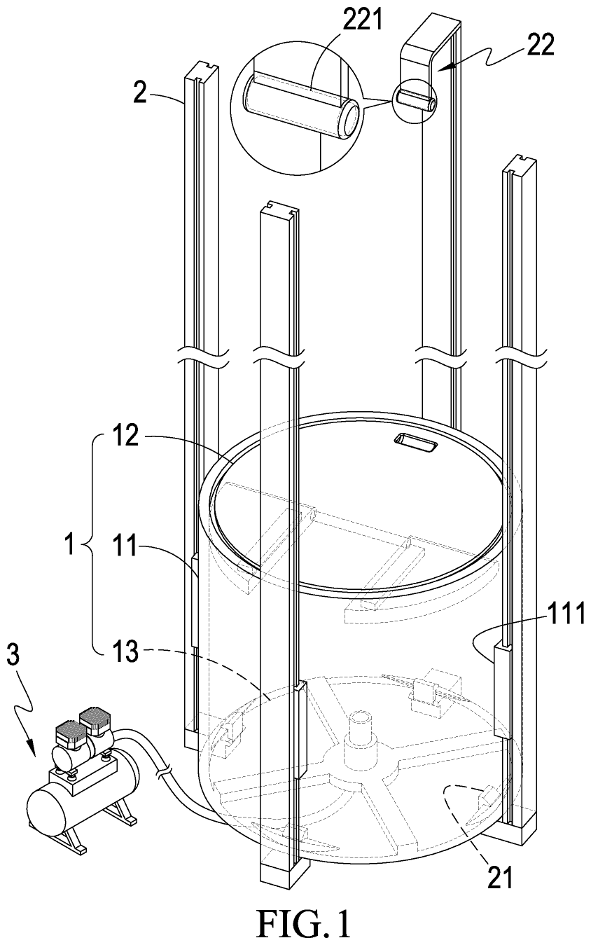

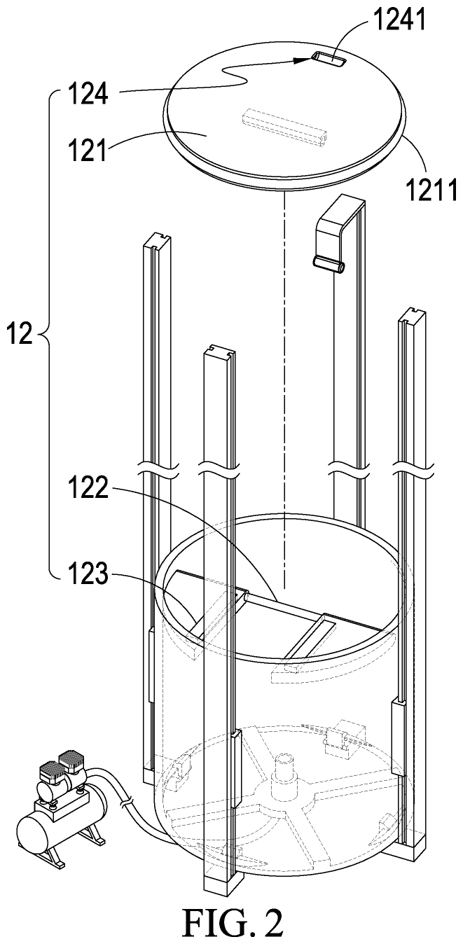

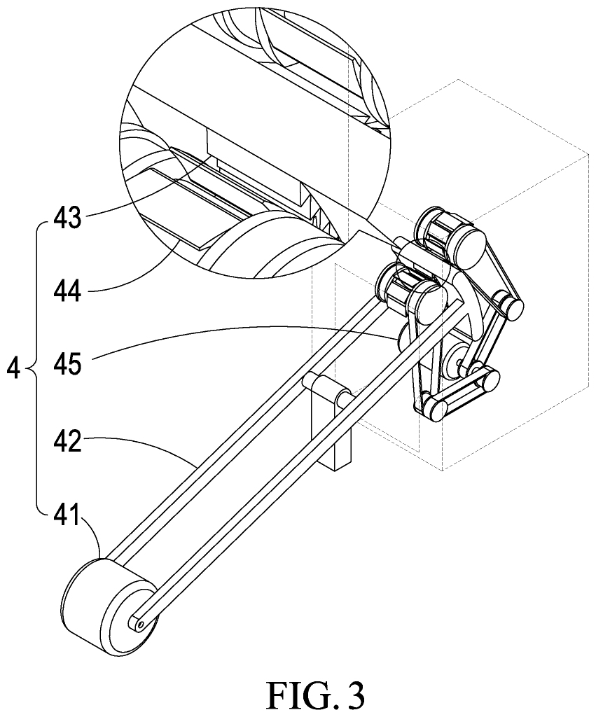

Referring to FIGS. 1 to 3, a structure of buoyancy power generation includes a buoyancy assembly 1, a plurality of rails 2, a plurality of fixing elements 21, an air supply device 3 and at least one wave power generation assembly 4, where the buoyancy assembly 1 is slidably connected to the rails 2. In a preferred embodiment, the buoyancy assembly 1 and rails are installed in a pool, but the present invention is not so limited; they also can be installed in an artificial pond or natural pond. One end of each rail 2 is positioned on the bottom of the pool and another end thereof outside the water surface of the pool, and the fixing element 21 is configured on the end of each rail 2 positioned on the bottom of the pool, thereby selectively fixing the buoyancy assembly 1 in the pool. Furthermore, the buoyancy assembly 1 includes a barrel 11, an exhaustion assembly 12 and a plurality of penetrations 13, where the barrel 11 is slidably installed on the rails 2, the exhaustion assembly 12 is configured on one side of the barrel 11, thereby selectively exhausting air inside the barrel 11, and the penetrations 13 is configured on the lower side of the barrel 11.

The exhaustion assembly 12 includes a cover 121, shaft 122, cover fixing assembly 123 and cover corresponding portion 124, where the shaft 122 is configured on the upper opening of the barrel 11, and the cover 121 is in connection with the shaft 133, capable of rotating around the shaft 122 so as to selectively cover the opening of the barrel 11. Furthermore, in the embodiment, the cover 121 has a sealing element 1211 configured to enclose the soft plastics on the cover, capable of strengthening closure for the opening, but the present invention is not so limited, the edge of the cover 121 may directly be used for sealing; the cover fixing assembly 123 is configured between the cover 121 and barrel 11, thereby selectively allowing the cover 121 to be fixed on the barrel 11 to seal the opening; the cover corresponding portion 124 is configured on one side of the cover 121 away from the cover fixing assembly 123. In the embodiment, the cover fixing assembly 123 is a magnetic element configured on the barrel 11, and the cover 121 itself is made of metal so that it can be attracted to the barrel 11 directly through the magnetic element.

The rails 2 has a rail corresponding portion 22 configured on the one end of one of the rails 2 penetrated out of the water surface and corresponding to the cover corresponding portion 124, where the rail corresponding portion 22 has a first corresponding magnetic element 221, and the cover corresponding portion 124 has a second corresponding magnetic element 1241. Whereby, the first corresponding magnetic element 221 and second corresponding magnetic element 1241 will be attracted to each other to drive the cover 121 to cause it not to cover the opening of the barrel 11 when the rail corresponding 22 and cover corresponding portion 124 are in touch with each other.

The wave power generation assembly 4 includes a buoy 41, a rod 42, two engagement portions 43, two ratchet assemblies 44 and a power generation device 45, where the rod 42 is coupled pivotally to the shore of the pool, and one end thereof deep in the water is configured with the buoy 41, and the lever action of the rod 42 can be actuated by the power provided by the buoy 41; the engagement portions 43 are configured on one end of the rod 42 away from the buoy 41; each ratchet assembly 44 is in engagement with the corresponding engagement portion 43 and in connection with the power generation device 45. When the lever action of the rod 42 is carried out, it will drive the ratchet assembly 44 to rotate to cause the power generation device 45 to generate power.

In the embodiment, the barrel 11 has a plurality of slide elements 111, allowing the barrel 11 to be slidably connected to the rails 2 through the slide elements 111, but the present invention is not so limited, the barrel 11 may be directly in slidable connection with the rails 2.

With the above description, the structure of the present technology can be understood, and according to the corresponding cooperation of this structure, the wave generated by buoyancy can be utilized to generate an environmentally friendly power source, and the detailed explanation will be described below.

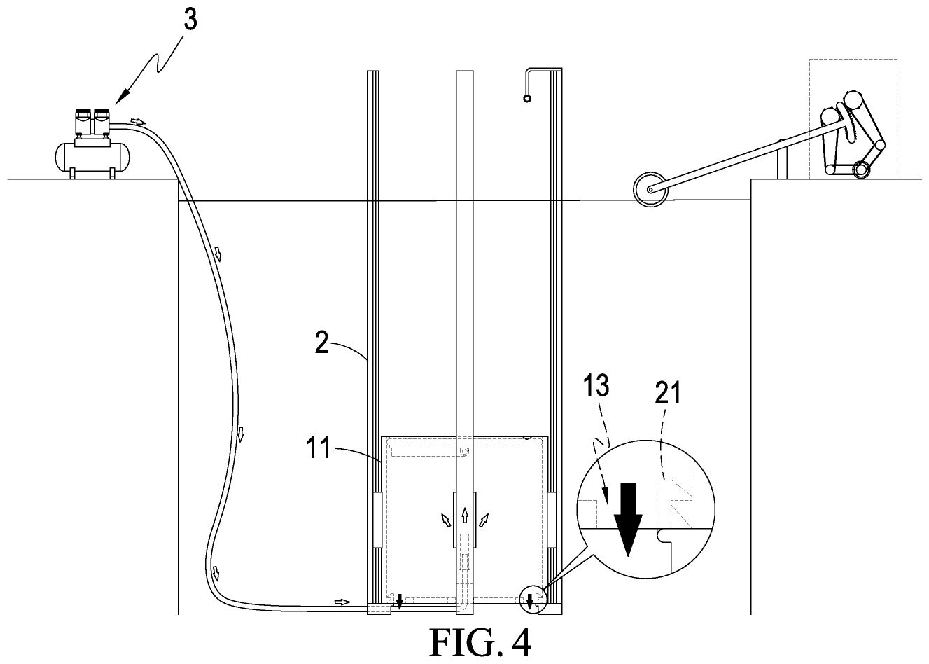

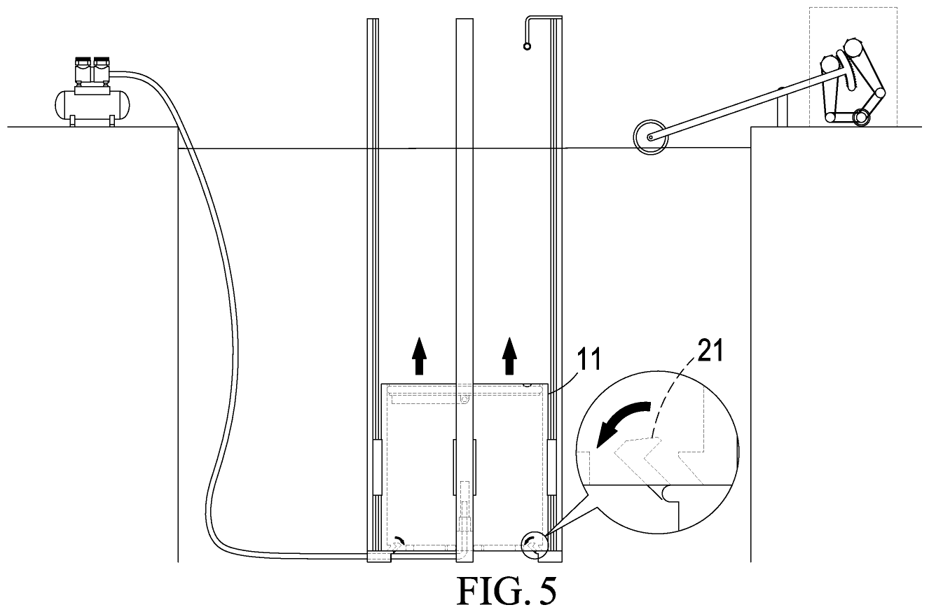

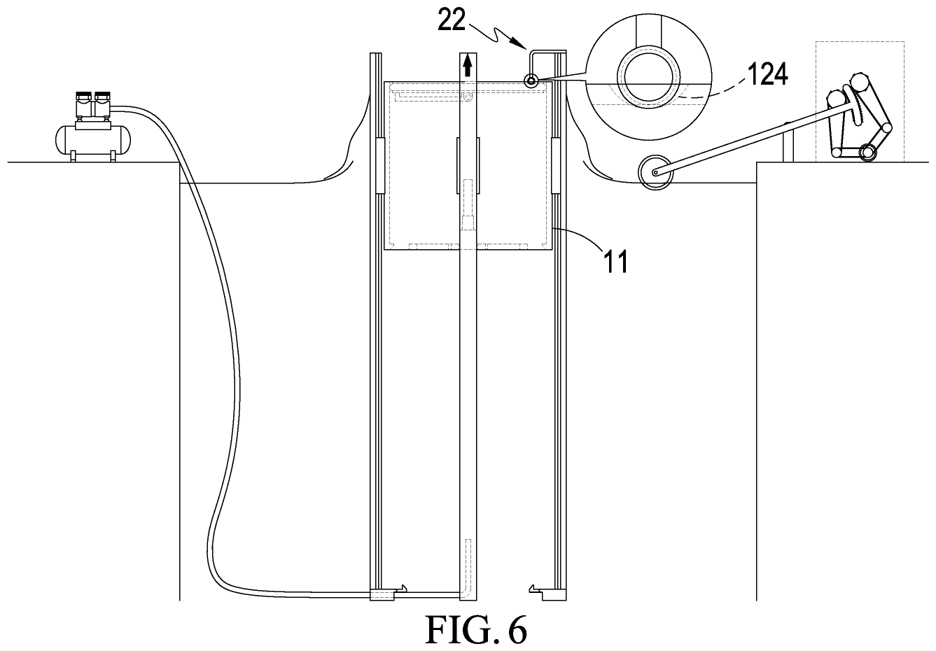

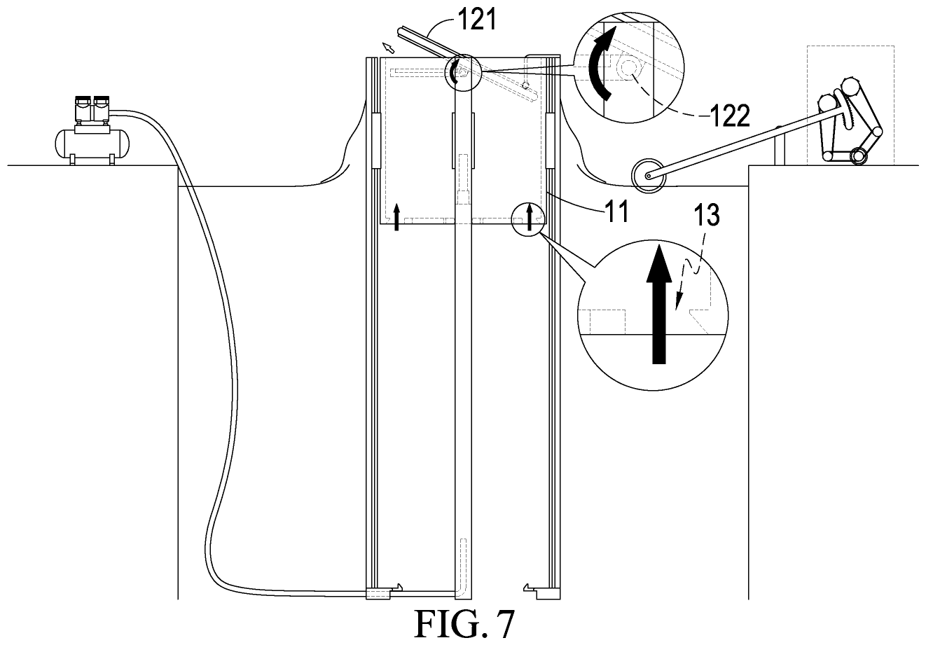

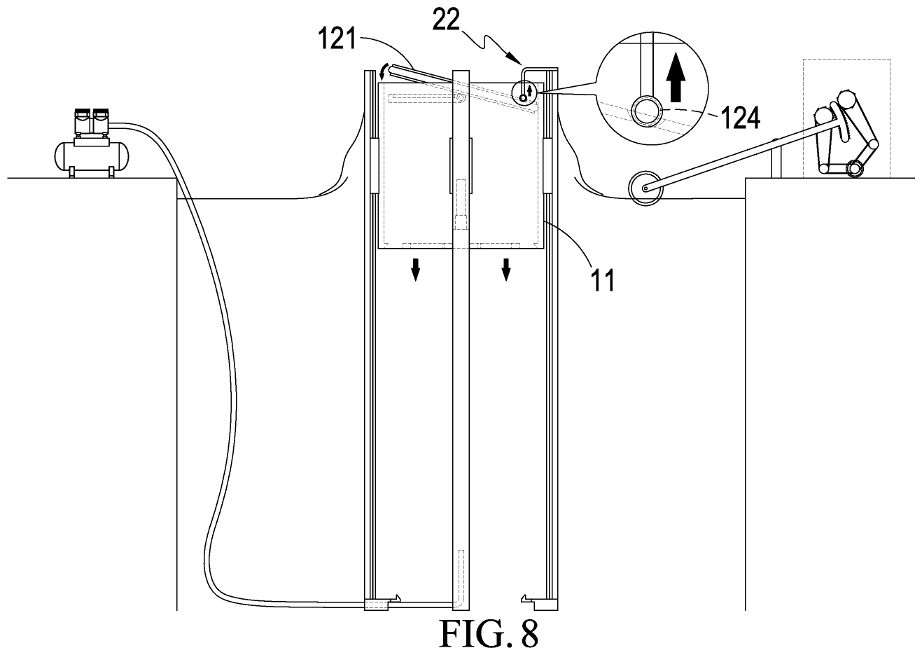

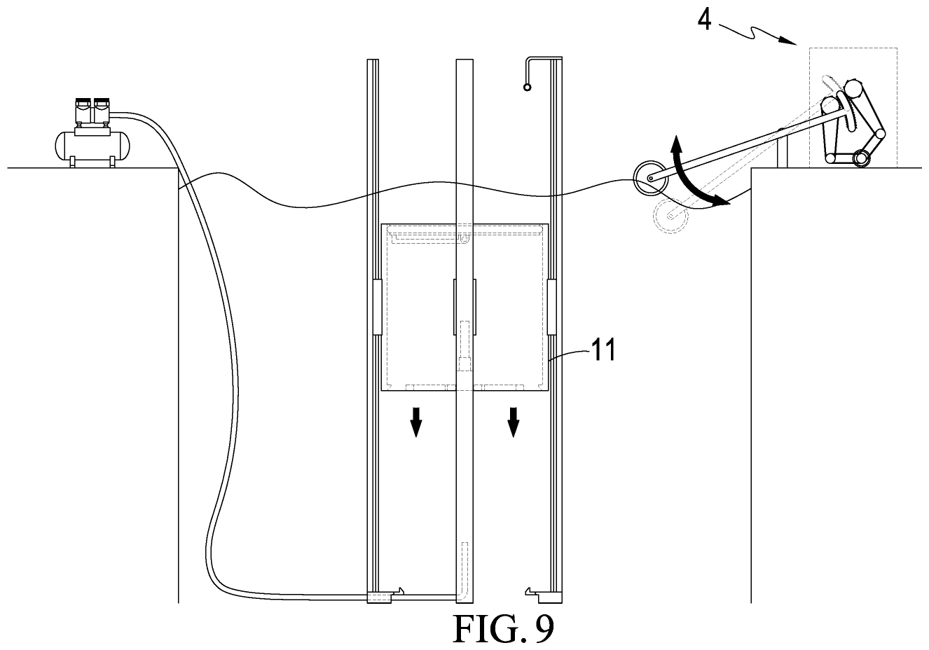

Referring to FIGS. 1 to 11, with the assembly of the above components, a user may control the air supply device 3 to introduce air into the barrel 11, thereby guiding out the water in the barrel 11 through the penetrates 13 to generate buoyancy when the barrel 11 is positioned at the bottoms of the rails and fixed by the fixing elements 21. When the air inside the barrel 11 reaches a preset amount and generate enough buoyancy, the user may control fixing element 21 to cause them to be separated from the buoy 41. In the embodiment, each fixing element 21 may be controlled by an electromagnetic valve, but the present invention is not so limited. The barrel 11 will approach the water surface along the rails 2 through the buoyancy generated by the air inside the barrel 11 after it is separated from and not fixed to the fixing elements 21. When the barrel 11 breaks out of the water surface, it will cause waves on the water surface, causing the buoy 41 in the wave power generation assembly 4 on the shore to float up and down with the waves of the water surface to generate power, and the cover corresponding portion 24 will be in touch with the rail corresponding portion 22 after the barrel 11 breaks out of the water surface, allowing the first corresponding magnetic element 221 and second corresponding magnetic element 1241 to be attracted to each other to push the cover 121 to rotate around the shaft 122 so as to open the opening of the barrel 11, allowing the air inside the barrel 11 to flow out of the barrel 11 and the water in the pool to flow into the barrel 11 through the penetrations 13. When the air is gradually guided out of the barrel 11 to allow the water to enter the barrel 11, the buoyancy of the barrel 11 is then gradually decreased to cause the barrel 11 to slide downward along the rails 2. When the barrel 11 slides downward, the cover corresponding portion 124 and rail corresponding portion 22 are still be attracted to each other, thereby driving the cover 121 to gradually cover back onto the barrel 11. When the cover 121 covers back on the barrel, the magnetic element in the cover fixing assembly 123 will attract the cover 121, and the force of attraction of the cover fixing assembly 123 will be greater than the force of the first corresponding magnetic element 221 and the second corresponding magnetic element 1241, thereby causing the cover corresponding portion 124 and rail corresponding portion 22 to be separated from each other so that the barrel 11 can be sunk into the pool bottom along the rails 2, and the barrel 11 is further fixed by the fixing elements 21. When waves want to be generated once more, the air supply device 3 can be used again to introduce air into the barrel 11 to make it float again.

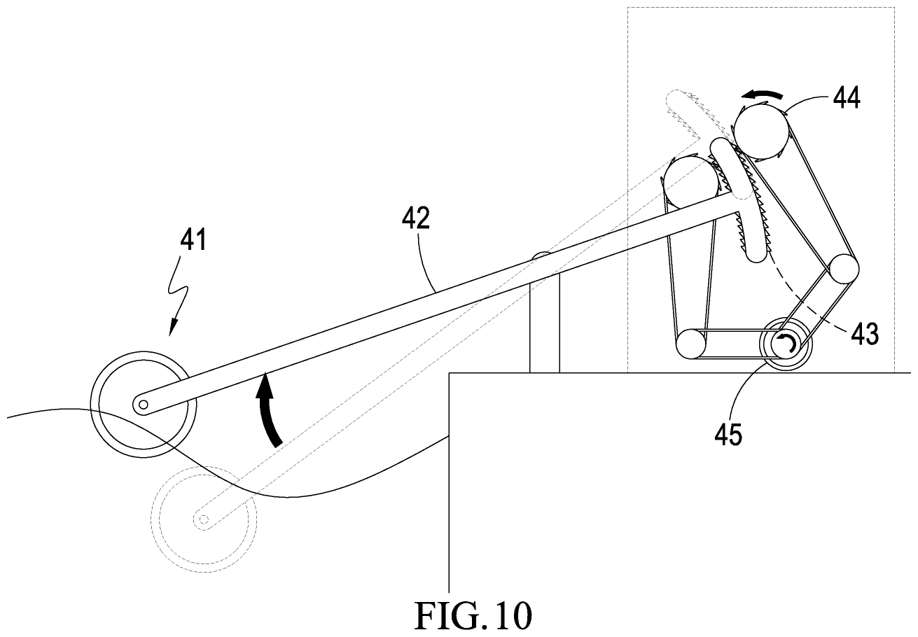

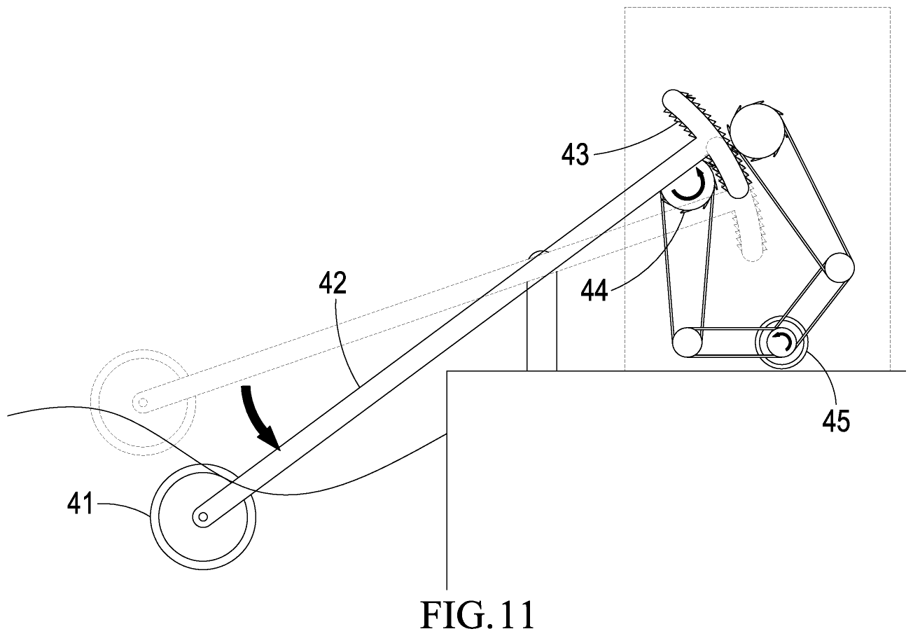

Referring again to FIGS. 10 and 11, showing the power generation method of the present invention, the buoy 41 will be moved up and down with waves to drive the rod 42 to carry out lever motion, thereby allowing the engagement portion 43 on another end to drive the ratchet assembly 44 to rotate; when the rod 42 is acted clockwise, one of the engagement portions 43 will be used to drive the ratchet assembly 42 on one side to rotate, and the ratchet assembly 44 will be used to drive the rotating shaft of the power generation device 45 to rotate anticlockwise. At this time, the ratchet assembly 44 on another side will not be rotated. When the rod 42 is moved anticlockwise to drive the engagement portion 43 and ratchet assembly 44 on another side to act, and similarly drive the rotating shaft of the power generation device 45 to rotate anticlockwise, which is the conventional technology of the ratchet, the detail thereof is omitted here. Thus, when whether the rod 42 is levered in any direction, it can drive one of the ratchet assemblies 44 to act and drive the rotating shaft of the power generation device 45 to rotate in the same direction, thereby continuously generating power.

In the above actions, air buoyancy is used to cause the water surface to generate waves, thereby utilizing the power generation assembly 4 to generate power with waves, and the wave power assembly 4 in this embodiment is only an example, the present invention is not so limited. The power generation of the present invention is very environmentally friendly because it will not generate any waste or pollution, and the volume of the barrel 11 and the number of the shore wave power generation assemblies 4 can still be changed according to user's requirements, thereby changing power generation efficiency so that the power generation efficiency is also quite sufficient. The entire cost is not too high because only changing the number and volume can change the amount of electricity generated so that the low-cost and high-efficiency environmentally friendly effect can be achieved.

However, the above description is only the preferred embodiment of the present invention, and thus does not limit the scope of the present invention. Therefore, all the simple modifications and equivalent structural changes that are made by using the present specification and the drawings are included in the scope of the present invention.

The present invention has the following advantage over the prior arts: the present invention uses the buoyancy assembly 1 to generate waves and achieves a low-cost and high-efficiency environmentally friendly power generation effect at the same time with wave power generation assembly 4.

I claim:

1. A structure of buoyancy power generation, comprising:
a buoyancy assembly, in slidable connection with at least on rail;
at least one fixing element, configured on said rail and adapted to selectively fix said buoyancy assembly;
an air supply device, in connection with one side of said buoyancy assembly and adapted to introduce air into said buoyancy assembly, allowing said buoyancy assembly to generate buoyancy; and
at least one wave power generation assembly, configured on one side of said buoyancy assembly and generating power through waves generated from said buoyancy assembly.

2. The structure according to claim 1, wherein said buoyancy assembly comprises a barrel, at least one exhaustion assembly and at least one penetration, said barrel is configured on said rail, said exhaustion assembly said barrel, and said penetration a lower side of said barrel.

3. The structure according to claim 2, wherein said exhaustion assembly comprises a cover, shaft, cover fixing assembly and cover corresponding portion, said shaft is configured on one side of said barrel, said cover is in connection with said shaft for the rotation thereof around said shaft and selectively covers one side of said barrel, said cover fixing assembly is configured between said cover and barrel, and said cover corresponding portion is configured on said cover and positioned on one side of said cover away from said cover fixing assembly.

4. The structure according to claim 3, wherein said cover has a sealing element.

5. The structure according to claim 3, wherein said rail has a rail corresponding portion corresponding to said cover corresponding portion.

6. The structure according to claim 5, wherein said rail corresponding portion has a first corresponding magnetic element, said cover corresponding portion has a second corresponding element, and said first corresponding magnetic element is adapted to be selectively attracted to said second corresponding magnetic element.

7. The structure according to claim 1, wherein said wave power generation assembly comprises at least one buoy, a rot, at least on engagement portion, at least one ratchet assembly and a power generation device, said buoy is configured on one end of said rod, said engagement portion another end of said rod away from said buoy, said ratchet assembly is in engagement said engagement portion, and said ratchet assembly is in connection with said power generation device.

8. The structure according to claim 1, wherein said buoyancy assembly has at least one slide element and in slidable connection with said rail through said slide element.

9. The structure according to claim 1, wherein said fixing element is controlled by an electromagnetic valve.
